(19) United States
(12) Patent Application Publication
(10) Pub. No.: US 2026/0260330 A1
(43) Pub. Date: Sep. 3, 2026

(54) AUTOMATED VISUAL INSPECTION SYSTEMS FOR VEHICLE MACHINING LINES

(71) Applicant: GM GLOBAL TECHNOLOGY OPERATIONS LLC, Detroit, MI (US)

(72) Inventors: Hua-tzu FAN, Troy, MI (US); Scott Alan Hucker, Ortonville, MI (US); Randall R. Warren, Culleoka, TN (US); Praveen Pilly, West Hills, CA (US); Krishna Choudhary, Studio City, CA (US); Neale Ratzlaff, Portland, OR (US)

(21) Appl. No.: 19/067,014

(22) Filed: Feb. 28, 2025

(51) Int. Cl. G06T 7/00; G06T 7/13

(52) U.S. Cl. CPC G06T 7/0004; G06T 7/13; G06T 2207/20081; G06T 2207/20084; G06T 2207/30164

(57) ABSTRACT

An inspection system includes a machining line configured to support an object, at least one camera adjacent to the machining line, the at least one camera configured to capture at least one image of the object and create a multi-channel image set of the image, and a control module in communication with the at least one camera. The control module is configured to receive the multi-channel image set of the image, detect a boundary associated with the object in the multi-channel image set, and detect, with a machine learning network, a defect on the boundary based on the multi-channel image set, a first training data set including annotated multi-channel image sets, and a second training data set including multi-channel image sets having artificially created defects. Other example inspection system and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to automated visual inspection systems for vehicle machining lines.

Vehicle components are commonly produced along machining lines. Some of the vehicle components, such as crankshafts, camshafts, etc. are high precision parts that require no defects larger than a few microns in dimension. For example, the vehicle crankshaft is an essential backbone of a vehicle engine that is responsible for transferring power from the internal combustion of gasoline within the cylinders into rotary motion that makes the wheels turn. In conventional machining lines, crankshafts are progressively machined step-by-step with ever decreasing tolerances to create the finished part from the initial raw work piece. While this machining process is highly refined and robust, on rare occasions the process may create defects on the crankshafts. Defects as small as a few microns in dimension can be catastrophic to the future utility of the engine. Conventionally, human operators are tasked with inspecting the crankshafts for such defects.

### SUMMARY

An inspection system for automatically detecting defects of an object, includes a machining line configured to support the object, at least one camera adjacent to the machining line, the at least one camera configured to capture at least one image of the object and create a multi-channel image set of the image, each channel of the multi-channel image set providing a distinct view of the object, and a control module in communication with the at least one camera. The control module is configured to receive the multi-channel image set of the image, detect a boundary associated with the object in the multi-channel image set, and detect, with a machine learning network, a defect on the boundary based on the multi-channel image set, a first training data set including annotated multi-channel image sets, and a second training data set including multi-channel image sets having artificially created defects.

In other features, the control module is configured to generate a control signal in response to detecting the defect on the object, and control, based on the control signal, an actuator to move the defected object to a defined location.

In other features, the detected defect on the object is one of a plurality of repeating defects associated with a plurality of objects, and the control module is configured to generate, based on the plurality of repeating defects, a notification signal to inspect a region of the machining line for creating the plurality of objects.

In other features, the camera is configured to capture the at least one image of the object as the object rotates.

In other features, the object is a vehicle crankshaft or a camshaft.

In other features, the multi-channel image set includes at least a normal channel, a specular reflection channel, a diffuse channel, a gloss ratio channel, and a shape channel, and the control module is configured to detect the boundary associated with the vehicle crankshaft or the camshaft in the diffuse channel based on a change in an image brightness in the diffuse channel.

In other features, the vehicle crankshaft or the camshaft includes at least one oil hole, and the control module is configured to detect at least one edge of the oil hole based on a combination of the diffuse channel and the gloss ratio channel, and detect a defect associated with the edge of the oil hole.

In other features, the machine learning network is a convolutional neural network, and the control module is configured to create a stack of overlapping patches from the multi-channel image set and detect, with the convolutional neural network, the defect on the boundary based on the stack of overlapping patches.

In other features, the second training data set includes at least one multi-channel image set of a deliberately defected object.

In other features, the second training data set includes at least one multi-channel image set created based on a transformation of a previous multi-channel image set of a defected object.

In other features, the machine learning network is continually trained based on annotated training data and unannotated training data.

An inspection method for automatically detecting defects of an object, includes creating a multi-channel image set from an image of the object captured by a camera, each channel of the multi-channel image set providing a distinct view of the object, detecting a boundary associated with the object in the multi-channel image set, and detecting, with a machine learning network, a defect on the boundary based on the multi-channel image set, a first training data set including annotated multi-channel image sets, and a second training data set including multi-channel image sets having artificially created defects.

In other features, the inspection method further includes generating a control signal in response to detecting the defect on the object, and controlling, based on the control signal, an actuator to move the defected object to a defined location.

In other features, the detected defect on the object is one of a plurality of repeating defects associated with a plurality of objects, and the inspection method further includes generating, based on the plurality of repeating defects, a notification signal to inspect a region of a machining line for creating the plurality of objects.

In other features, the object is a vehicle crankshaft or the camshaft, and creating the multi-channel image set from the image of the object captured by camera includes creating the multi-channel image set from the image of the vehicle crankshaft or the camshaft captured by camera as the vehicle crankshaft or the camshaft rotates.

In other features, the multi-channel image set includes at least a normal channel, a specular reflection channel, a diffuse channel, a gloss ratio channel, and a shape channel, and detecting the boundary associated with the object includes detecting the boundary associated with the vehicle crankshaft or the camshaft in the diffuse channel based on a change in an image brightness in the diffuse channel.

In other features, the machine learning network is a convolutional neural network, the inspection method further includes creating a stack of overlapping patches from the multi-channel image set, and detecting the defect on the boundary includes detecting, with the convolutional neural network, the defect on the boundary based on the stack of overlapping patches.

In other features, the machine learning network is continually trained based on annotated training data and unannotated training data.

In other features, the second training data set includes at least one multi-channel image set of a deliberately defected object and at least one multi-channel image set created based on a transformation of an existing multi-channel image set of a defected object.

An inspection system for automatically detecting defects of a vehicle crankshaft, includes a machining line configured to support the vehicle crankshaft, at least one camera adjacent to the machining line, the at least one camera configured to capture at least one image of the vehicle crankshaft as the vehicle crankshaft rotates and create a multi-channel image set of the image, each channel of the multi-channel image set providing a distinct view of the vehicle crankshaft, and a control module in communication with the at least one camera. The control module is configured to receive the multi-channel image set of the image, detect a boundary associated with the vehicle crankshaft in the multi-channel image set, and detect, with a machine learning network, a defect on the boundary based on the multi-channel image set, a first training data set including annotated multi-channel image sets, and a second training data set including at least one multi-channel image set of a deliberately defected vehicle crankshaft and at least one multi-channel image set created based on a transformation of a previous multi-channel image set of a defected vehicle crankshaft.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an inspection system for automatically detecting defects of an object, according to the present disclosure;

FIG. 2 depicts a multi-channel image set for a journal surface of a vehicle crankshaft, including a diffuse channel, a gloss ratio channel, a shape channel, a normal channel, and a specular reflection channel, according to the present disclosure;

FIG. 3 depicts a set of images associated with the detection and analysis of an oil hole in a vehicle crankshaft, according to the present disclosure;

FIG. 4 depicts a stack of overlapping patches corresponding to a portion of the diffuse channel, the gloss ratio channel, the shape channel, the normal channel, and the specular reflection channel of FIG. 2 and two supplemental position patches, according to the present disclosure;

FIG. 5 is a block diagram of a system for creating a supplemental, artificial dataset, according to the present disclosure;

FIG. 6 is a frequency map for a set of analyzed crankshafts, showing that a defect has repeated occurred at the same location on the crankshafts, according to the present disclosure;

FIG. 7 is a block diagram of a system to implement continual learning for a machine leaning network of FIG. 1, according to the present disclosure;

FIGS. 8-9 are flowcharts of example inspection methods for automatically detecting defects of an object, according to the present disclosure; and

FIGS. 10-11 are graphs plotting performance accuracy over multiple rounds of continual learning of a machine learning network employable in the inspection system of FIG. 1, according to the present disclosure.

In the drawings, reference numbers may be reused to identify similar and/or identical elements.

### DETAILED DESCRIPTION

High precision vehicle components are commonly produced along machining lines. Such components (e.g., crankshafts and camshafts) are often progressively machined step-by-step with ever decreasing tolerances to create the finished part from the initial raw work piece, and require no defects larger than a few microns in dimension. For example, defects as small as a few microns in dimension can be catastrophic to the future utility of a vehicle engine. As such, identifying such components with defects before their incorporation into a vehicle engine is essential.

Conventionally, human operators are tasked with inspecting the components for defects. This inspection process performed by human operators is tedious and an imperfect task of visual inspection. For example, with respect to vehicle crankshafts, an operator must inspect a crankshaft and reject a defective part based on a visual inspection of about 200 cm² of metal surface in a short period of time. The human operator may then repeat this process about 250 times per shift, which means each crankshaft gets a total inspection time of about 30 seconds. This conventional inspection process is susceptible to errors associated with missed defects as the human operator may not spot the defects with their naked eyes due to fatigue, lack of time, inability to see the defects, etc. Such undetected defects may result in catastrophic events caused by the incorporation of defective parts into working engines.

The automated visual inspection systems and methods according to the present disclosure leverage artificial intelligence to enable an end-to-end visual inspection of objects, such as crankshafts, camshafts, etc. on a machining line. The inspection systems and methods specifically focus on the automated detection and characterization of surface defects such as scratches, dents, smudges, etc. on the objects, as well as checking the presence of characteristics related to features (e.g., oil holes) of the objects. In various embodiments, and as further explained herein, the inspection systems and methods create a multi-channel image set from an image of the inspecting object captured by a camera, and then detect, with a machine learning network, a defect on a boundary of the object based on the multi-channel image set and received annotated multi-channel image sets and multi-channel image sets having artificially created defects.

By leveraging artificial intelligence to enable end-to-end visual inspection, the inspection systems and methods herein achieve better-than-human-level inspection metrics, specifically excelling in the detection and characterization of surface defects like scratches, dents, smudges, etc., some of which are undetectable by human operators. In doing so, the systems and methods enhance precision and reliability, contributing to elevated product quality. Additionally, unlike manual inspections relying on human operators, the automated solutions herein may operate continuously, potentially enabling 24/7 operation of the machining line, thereby increasing production efficiency. As such, the advantages of employing the systems and methods extend to cost reduction through the minimization and potential elimination of human labor and the mitigation of risks associated with missed defects, potentially preventing warranty claims, product recalls, and catastrophic events caused by the incorporation of defective parts into working engines.

Additionally, while the embodiments herein are described in relation to the inspection of vehicle crankshafts, it should be appreciated that the inspection systems and methods herein may be employed in other vehicle objects (e.g., camshafts) and/or other non-vehicle industries. For example, the systems and methods showcase adaptability, indicating the application in a diverse range of manufacturing scenarios, further emphasizing its significance in advancing quality control and production processes. In some examples, the objects may have multiple planar parts as well as curved surfaces, and/or planar (e.g., flat) surfaces. In such cases, and as further explained herein, if an object has curved surfaces, a multi-channel image set may be utilized with the model, and if an object has flat surfaces, traditional rectangular images may be utilized with the model.

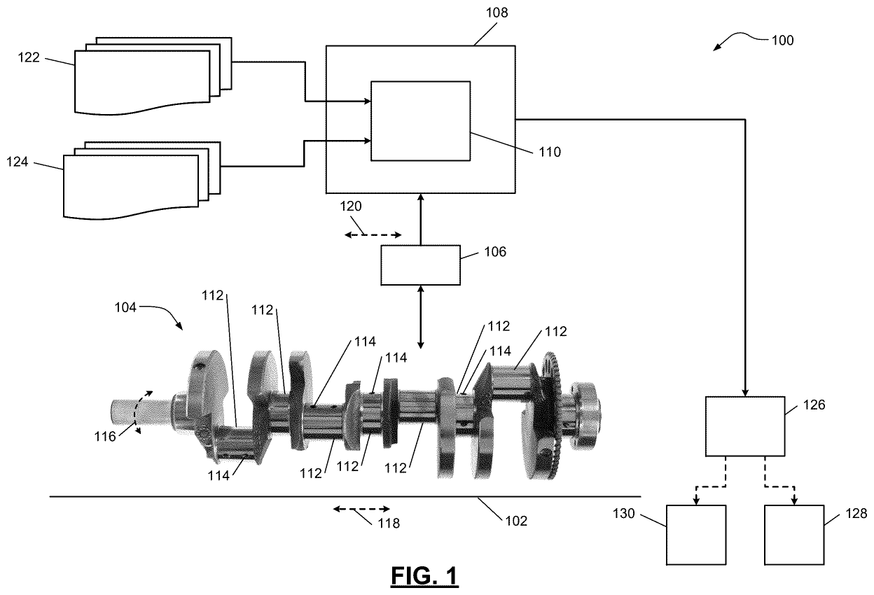

Referring now to FIG. 1, a block diagram of an example inspection system 100 is presented for automatically detecting defects of an object. As shown in FIG. 1, the inspection system 100 generally includes a machining line 102, at least one camera 106 adjacent to the machining line 102, and a control module 108 in communication with the camera 106 for automatically detecting defects of an object.

In the example of FIG. 1, the inspection system 100 automatically detects defects associated with a vehicle crankshaft 104. In such examples, the vehicle crankshaft 104 generally includes various journals 112 and oil holes 114 drilled into some or all of the journals 112. In various embodiments, the journals 112 may include main journals and connecting rod journals. When the crankshaft 104 is installed, the main journals may be clamped into the engine block. The connecting rod journals nay be secured to ends of connecting rods, which run up to pistons in the engine. While the inspection system 100 of FIG. 1 is shown as inspecting the vehicle crankshafts, it should be appreciated that inspection system 100 may inspect other suitable objects, such as vehicle camshafts, objects (e.g., vehicle or non-vehicle objects) having multiple planar parts as well as curved surfaces, etc.

As shown, the machining line 102 generally supports the vehicle crankshaft 104. In such examples, the machining line 102 may include a movable conveyor. In such examples, the vehicle crankshaft 104 may rest on the conveyor (e.g., a support extending from the conveyor) as the conveyor moves into and out of the viewable frame of the camera 106, as shown by a dashed line 118. In other examples, the camera 106 may move along the length of the vehicle crankshaft 104 (as shown by a dashed line 120).

The camera 106 of FIG. 1 may be any suitable type of camera capable of creating a multi-channel image set of a captured image. For example, the camera 106 may be a line scan camera to capture high-resolution images of the crankshaft 104, and specifically a surface of one of the journals 112. In such examples, the line scan camera is a high-speed camera that captures a single line of pixels at a time, while also capturing data across multiple different spectral bands (or channels) within the light spectrum, allowing for multispectral imaging analysis of the crankshaft 104 as it passes by the camera 106. While the discussion below may focus on the detection of defects on a surface of one of the journals 112, it should be appreciated that the inspection system 100 may detect defects on surfaces of any one of the journals 112 of the crankshaft 104.

In the example of FIG. 1, the camera 106 captures at least one image of the crankshaft 104 (e.g., a surface of one of the journals 112). In various embodiments, the camera 106 may capture the image of the crankshaft 104 as the crankshaft 104 rotates, as indicated by a dashed line 116. For example, the vehicle crankshaft 104 may rest on a support of the machining line 102 that causes the crankshaft 104 to rotate as the machining line 102 moves or as the camera 106 moves. This enables the camera 106, which can capture a single line of pixels at a time, to obtain a panoramic image of the crankshaft 104.

The camera 106 then creates a multi-channel image set of the captured image. In such examples, each channel of the multi-channel image set provides a distinct view of the crankshaft 104, and more specifically, a distinct view of the surface of one of the journals 112. These multiple channels may be specialized for extracting different types of defects. In various embodiments, the multi-channel image set may include five channel images (or another suitable number of channel images) obtained after post-processing the raw images from the camera 106. Each channel represents the unwrapped journal (e.g., panoramic view) in each of the different channel filters. In various embodiments, the channels may include, for example, at least a normal channel, a specular reflection channel, a diffuse channel, a gloss ratio channel, and a shape channel. To consolidate this information effectively, the channels may be stacked, resulting in a 5-channel image that encapsulates comprehensive details about the journal surface.

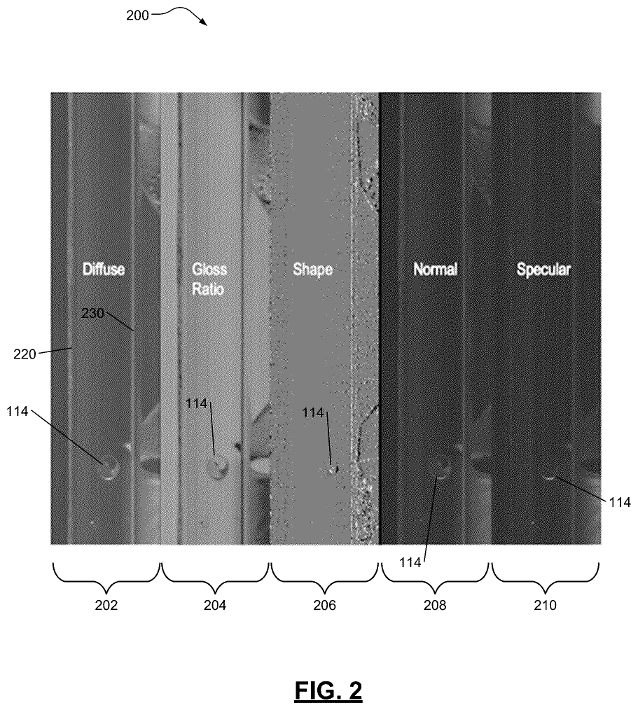

For example, FIG. 2 depicts a multi-channel image set 200 for a surface of one of the journals 112 in the crankshaft 104 of FIG. 1. As shown, the multi-channel image set 200 includes a diffuse channel 202, a gloss ratio channel 204, a shape channel 206, a normal channel 208, and a specular reflection channel 210, each of which are stacked together resulting in a 5-channel image. Each different channel 202, 204, 206, 208, 210 provides a distinct view of the surface of one of the journals 112 having an oil hole 114. In the example of FIG. 2, the diffuse channel 202 may represent the base color of the journal surface, determining its overall appearance under lighting. Additionally, the gloss ratio channel 204 may be used to control the distribution of specular highlights, indicating how smooth or rough the journal surface is, and the specular reflection channel 210 may be used to control the level of glossiness on different parts of the journal surface. Further, the shape channel 206 may be used to control a grayscale map that affects the shape of the journal surface to allow for more pronounced journal surface details, and the normal channel 208 to provide information about the surface normal at each pixel.

Referring back to FIG. 1, the control module 108 includes a machine learning network 110, such as a convolutional neural network (CNN) classifier, etc. that is trainable based on raw data collection (e.g., images from the camera 106) and annotations thereof, along with artificially augmented data as further explained below. For example, and as shown in FIG. 1, the control module 108 receives annotated image sets 122 and image sets 124 with artificially created defects for training the machine learning network 110 and detecting defects on a crankshaft.

In various embodiments, the annotated image sets 122 may be created based on one or more multi-channel image sets, such as the multi-channel image set 200 of FIG. 2. For example, the control module 108 (or another control module) may receive the multi-channel image set 200 and then process the multi-channel image set 200 to verify essential criteria for an acceptable journal surface. This includes ensuring that a boundary of the journal 112 does not contain undercuts and that the oil holes 114 within the journal 112 are drilled properly.

To establish a ground truth for boundary detection, a test journal may be marked with reflective paint at its boundaries. Standard computer vision techniques, leveraging a CV2 Python library, may be employed to threshold the multi-channel image set 200 and extract boundary information. The adaptive thresholds used are responsive to changes in image brightness, accommodating various factory lighting settings. This boundary detection process may be applied to one or more of the channels, such as the diffuse channel 202 shown in FIG. 2. In such examples, the control module 108 (or another control module) may detect boundaries 220, 230 associated with the vehicle crankshaft 104 in the diffuse channel 202 of FIG. 2 based on a change in an image brightness in the diffuse channel 202.

The quality of the oil holes may be assessed, with a focus on detecting sharp edges that may be detrimental to the crankshaft 104. In some examples, the control module 108 (or another control module) may implement an algorithm (e.g., a “rising sea level” method) which analyzes a gradual increase of a surface of the oil hole 114 over time to detect the inner and outer edges of the oil hole 114. This may provide a metric for judging the quality of oil hole drilling.

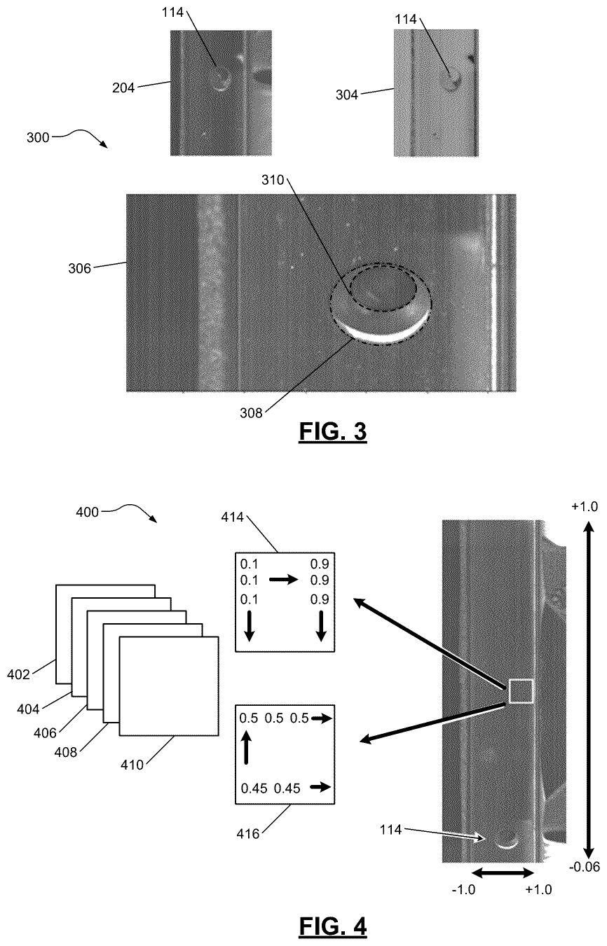

In various embodiments, the diffuse channel 202 and the gloss ratio channel 204 of the multi-channel image set 200 in FIG. 2 may be employed for oil hole analysis. For example, FIG. 3 depicts example a set 300 of images associated with the detection and analysis of one of the oil holes 114 in the crankshaft 104 of FIG. 1. In FIG. 3, the images include the image of the gloss ratio channel 204 of FIG. 2 for a sample journal surface with the oil hole 114, and images 304, 306. The image 304 is created by the control module 108 (or another control module) to represent the image of the gloss ratio channel 204 combined with the diffuse channel 202, where the combined image is then put under a threshold such that only a certain percent of pixels is highlighted. Outlines (e.g., edges) of inner and outer holes are then detected by the control module 108 (or another control module) by using contours, taking the convex hull, and then fitting ellipses 308, 310, as shown in the image 306.

Then, the control module 108 (or another control module) may create a stack of overlapping patches from the multi-channel image set 200. For example, following the boundary and oil hole detection explained above, the control module 108 may split the multi-channel image set 200 into overlapping patches. This creates a stack having a three-dimensional size, such as a size of 750×740×5 pixels. This may facilitate downstream processing and ensure the comprehensive representation of the journal surface within the boundaries (e.g., the boundaries 220, 230 of FIG. 2), considering the circular nature of the sample journal 112. Two additional channels capturing the location of each patch with respect to the detected oil hole 114 may be introduced. This positional information may be crucial for capturing defects that may occur regularly at specific positions during machining operations.

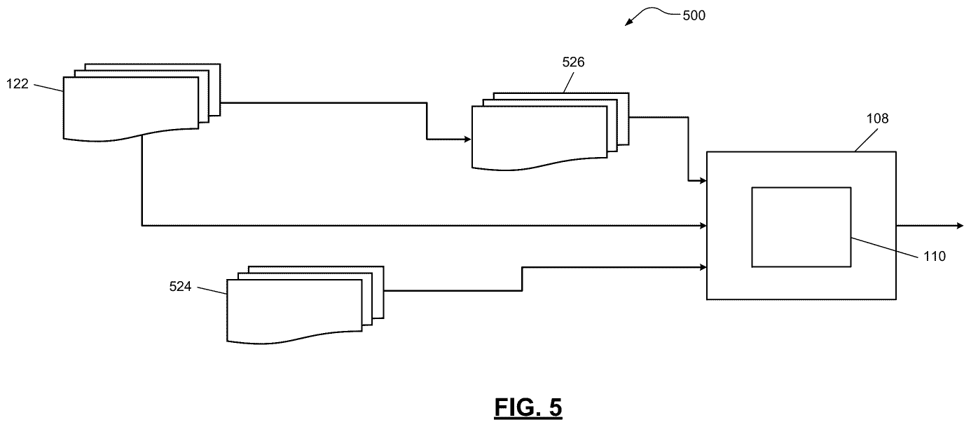

As one example, FIG. 4 depicts a stack 400 of overlapping patches (or pixels) 402, 404, 406, 408, 410 corresponding to a portion of the diffuse channel 202, the gloss ratio channel 204, the shape channel 206, the normal channel 208, and the specular reflection channel 210 of FIG. 2, respectively. To incorporate positional information for each patch 402, 404, 406, 408, 410, the control module 108 can supplement the 5-channel patches 402, 404, 406, 408, 410 with two additional images (or patches) 414, 416 of equal size as the patches 402, 404, 406, 408, 410. In such examples, the two additional images 414, 416 may be created to include the “x” and “y” positions of each patch 402, 404, 406, 408, 410. In this example, the center of the outer fitting ellipse (e.g., the ellipse 308 of FIG. 3) of the oil hole 114 may be taken as the origin, and the positions of the patches 402, 404, 406, 408, 410 may be normalized to +1 and −1 in both directions. Each patch 402, 404, 406, 408, 410 may then be supplemented with the two images 414, 416, one for the x position value of each patch, and one for the y value. This results in a 7-channel stack.

In various embodiments, the multi-channel image set 200 in FIG. 2, along with other multi-channel image sets, may be analyzed and annotated by a human operator to create the annotated image sets 122. In such examples, the human operator may be an expert familiar with the crankshaft 104 and the machining line 102. In some examples, the annotations, denoting OK (e.g., non-catastrophic defects) and not-OK or NOK (e.g., catastrophic defects), may be color-coded and overlaid onto one of the channel images of the multi-channel image set (e.g., the multi-channel image set 200).

For instance, the non-catastrophic defects (OK) may be annotated in green with the type of defect identified (e.g., smudge) and the catastrophic defects (not-OK or NOK) may be annotated in red with the type of defect identified (e.g., dimple and scratch). In other examples, the color-coded annotations may be based on the type of defect, the category of which may be deduced from the annotation line color. In such examples, each type of defect may correspond to a different defined color. As example only, the types of defect may include a no clean up (NCU) machining mark, a scratch, a grind (missed polish), rust, rough tape (missed finish polish), a dimple (indent, peen), porosity, a reflection, a smudge, a spot, a water spot, etc. Additionally, in some examples, the color-coded annotations may include a notation for a perfect part which corresponds to another defined color.

In various embodiments, the multi-channel image sets may be analyzed for annotations simultaneously with the generated patches explained above. With this approach, the control module 108 may assign a tag to each patch based on whether it contains defects. In such examples, a particular patch may be considered defective (e.g., NOK) if a bounding box of the annotation overlaps, with at least 25% coverage, indicating a potential defect in that patch. This annotated data serves as the ground truth for training the machine learning network 110, ensuring the accurate identification of defects in subsequent inspection processes.

As referenced above, the control module 108 of FIG. 1 additionally receives the image sets 124 with artificially created defects for training the machine learning network 110 and detecting defects on a crankshaft. Such artificially created data provides a supplement to the annotated image sets 122, addressing the challenge of the rarity of defects and the consequent imbalance between defective (NOK) and non-defective (OK) patches explained above. For example, traditional machine learning approaches for anomaly detection typically necessitate extensive training on large datasets to effectively capture the real distribution of defects. However, this approach faces significant challenges in the context of machining lines for precision parts, such as with vehicle crankshafts. An inherent drawback of traditional machine learning for anomaly detection is its requirement for a well-representative sampling of the real distribution of defects, which is particularly problematic when dealing with rare defects in machining lines. In these scenarios, the defects themselves are underrepresented in the training dataset, leading to a lack of robustness in the detection model. Moreover, the distribution of defect types is non-uniform, with certain defects, like dimples on the metal surface, being rarer than others such as scratches. This non-uniformity further complicates the training process and diminishes the effectiveness of traditional machine learning techniques. As such, the image sets 124 with artificially created defects in combination with the annotated image sets 122 provide a robustness training set with uniform distribution of defect types for the machine learning network 110.

The supplemental, artificial dataset may be created with multiple approaches to supplement the defective (NOK) data and ensure a balanced dataset for effective machine learning model training. For example, with one approach, the artificially created training data set (e.g., the image sets 124) may include one or more multi-channel image sets of one or more deliberately defected vehicle crankshafts (or another suitable object being analyzed). In such examples, defects are manually induced by human operators deliberately causing damage to normal crankshafts using tools, such as hammers, drills, punches, etc. to induce catastrophic defects onto an otherwise acceptable journal surface. These defective crankshafts are then incorporated into the machining line 102 and imaged by the camera 106, thereby providing a realistic representation of defects in the dataset. Notably, these defects exhibit high density and regular spacing, offering unique insights into the impact of induced defects on the journal surface.

Additionally, and/or alternatively, the artificially created training data set (e.g., the image sets 124) may include one or more multi-channel image sets created based on transformations of previous multi-channel image sets of defected vehicle crankshafts (or another suitable object being analyzed). In such examples, new artificial defects may be created through transformations on existing defective (NOK) patches, thereby creating new instances in the training dataset. For instance, a large existing defective (NOK) patch may be transformed by randomly rotating and/or flipping and then extracting a smaller portion (e.g., a central 750×750-pixel patch) of the large patch to create the new artificial defective (NOK) patch if the extracted patch still contains the bounding box of the defect. In various embodiment, transformations may be applied selectively, with a focus on under-represented defect types within the defective (NOK) dataset, such as dimples, scratches, and smudges. In this example, the goal is to enhance diversity and comprehensiveness in the training set by augmenting the sparsity of the defective (NOK) dataset.

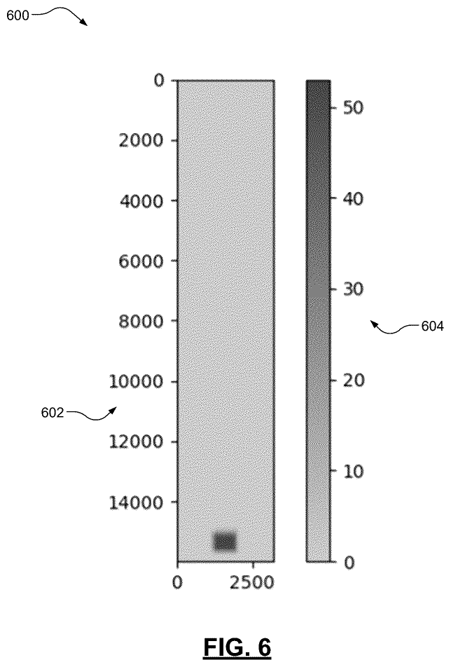

FIG. 5 defects a system 500 for creating the supplemental, artificial dataset. As shown, the system 500 includes a data augmentation module 508 that receives the annotated image sets 122 with existing defective (NOK) patches and then transforms the existing defective (NOK) patches into new multi-channel image sets 526 with new defective (NOK) patches. The new multi-channel image sets 526 with new defective (NOK) patches are then passed to the control module 108 for training the machine learning network 110 (e.g., a CNN classifier), along with the annotated image sets 122 with existing defective (NOK) patches, and multi-channel image sets 224 with defective (NOK) patches created from deliberately defected vehicle crankshafts, as explained above.

With continued reference to FIG. 1, the machine learning network 110 may be a CNN classifier. In this case, the training dataset, enriched through diverse augmentation techniques, serves as the foundation for training the neural network to predict the presence of defects (e.g., label 0) or the absence of defects e.g., label 1) in a given patch. In some examples, the CNN classifier may be a ResNet-50 neural network tailored to accommodate the 7-channel image constituting the patch dataset. In such examples, the final layer of the neural network includes two neurons, facilitating binary classification (label 0 or label 1), a departure from the default 1000-neuron layer designed for ImageNet image classification. In various embodiments, the training procedure for the machine learning network 110 may employ the Adam optimizer and extend over 100 epochs.

In various embodiments, given the inherent asymmetry in our dataset, with non-catastrophic defect (OK) patches outnumbering defective (NOK) patches due to the rarity of defects, data balancing strategies may be employed. For example, the defective (NOK) patches may be artificially weighted to equalize their importance during training, ensuring the CNN classifier encounters an equal number of non-catastrophic defective (OK) and defective (NOK) instances during each epoch. Furthermore, within the defective (NOK) dataset, each patch may be weighted based on the type of defect it contains, ensuring equal representation for each defect type throughout the training process. This approach enhances the CNN classifier's ability to recognize and characterize defects before being evaluated on the test set.

In various embodiments, the inspection system 100 may implement multiple combined machine learning models to make predictions. In other words, ensembling may be employed to further enhance performance. For example, multiple CNN classifiers, initialized with different random seeds, may be trained on the same dataset. In such examples, predictions from these distinct classifiers may be combined using a democratic voting scheme, mitigating the impact of outlier predictions and avoiding idiosyncrasies that may arise from training on limited data. An odd number of classifiers is preferred for ensembling to prevent tie situations, ensuring a robust and reliable defect prediction system.

Once the machine learning network 110 is sufficiently trained, the inspection system 100 may implement the machine learning network 110 to detect anomalies associated with a vehicle crankshaft (e.g., the vehicle crankshaft 104) or another suitable object on which the machine learning network 110 is trained. For example, as shown in FIG. 1, the camera 106 captures images of a vehicle crankshaft (e.g., the crankshaft 104 or another crankshaft) as the crankshaft rotates and creates multi-channel image sets of the images, as explained above. The control module 108 then receives the multi-channel image sets, detects a boundary associated with the crankshaft in the multi-channel image sets, and then detects, with the trained machine learning network 110, a defect on the boundary based on the multi-channel image sets, and the training data sets (e.g., the annotated image sets 122 and the image sets 124 with artificially created defects). In some examples, the control module 108 may create a stack of overlapping patches from the multi-channel image set created by the camera 106 as explained above, and then detect the defect on the boundary based on the stack of overlapping patches. Additionally, the control module 108 may detect at least one edge of an oil hole (e.g., one of the oil holes 114) of the crankshaft based on a combination of a diffuse channel and a gloss ratio channel from the multi-channel image set created by the camera 106 and then detect a defect associated with the edge of the oil hole, as explained above.

In various embodiments, the inspection system 100 of FIG. 1 may implement control functions based on an output of the machine learning network 110. For example, and as shown in FIG. 1, the inspection system 100 may further include an actuator 126 in communication with the control module 108. In such examples, the control module 108 may generate a control signal in response to the machine learning network 110 detecting the defect on the vehicle crankshaft. Then, the control module 108 may then transmit the control signal to the actuator 126 to control the actuator 126 to move the defected vehicle crankshaft to a defined location, such as a defect bin 128. In other examples, the control module 108 may generate another control signal in response to the machine learning network 110 not detecting the defect on the vehicle crankshaft. In such examples, the control module 108 may transmit this control signal to the actuator 126 to control the actuator 126 to move the defected vehicle crankshaft to another defined location, such as a non-defect bin 130.

In still other examples, the control module 108 may generate a notification signal to inspect a region of the machining line 102 for creating the plurality of objects. For example, a defect on the vehicle crankshaft detected by the machine learning network 110 may be one of multiple repeating defects associated with analyzed crankshafts. In such examples, the control module 108 (or another control module) may generate a frequency map (e.g., a heat map) for a set of analyzed crankshafts showing a particular defect reoccurring in the same spot (e.g., at a bottom of a particular journal). If such scenarios occur, the control module 108 may generate, based on the multiple repeating defects, a notification signal to inspect a region of the machining line 102 in an attempt to resolve a potentially defect creating issue along the machining line 102.

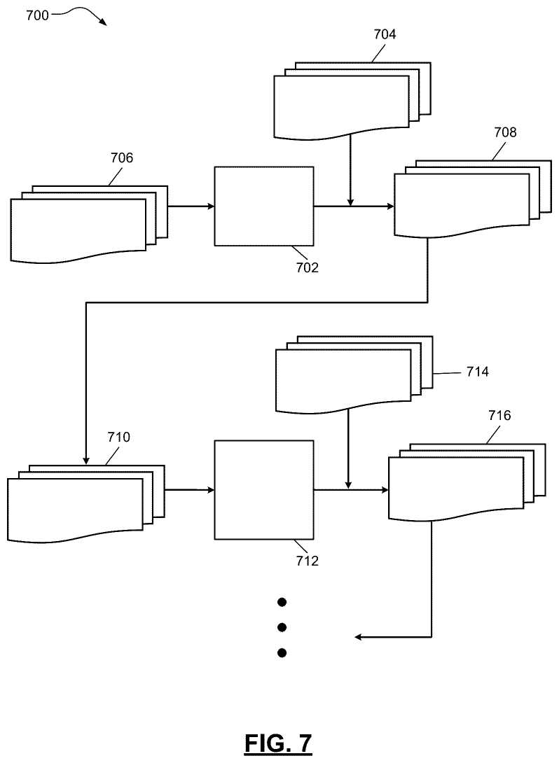

As one example, FIG. 6 illustrates a frequency map 600 for a set of analyzed crankshafts, showing that a scratch-type defect has occurred in the same spot at a bottom of a particular journal of a high number of crankshafts. In this example, the frequency map 600 includes location coordinates 602 to locate an identified area of the crankshafts and a frequency range 604 to indicate the number of similar defects detected at the same spot.

With continued reference to FIG. 1, the machine learning network 110 may be improved over time by continually training the machine learning network 110 based on annotated training data and unannotated training data. In such examples, the inspection system 100 may use feedback between one or more human experts (e.g., operators) that annotate data sets and the model outputs (e.g., unannotated data sets) to incrementally improve the machine learning network 110 with each iteration of training-testing.

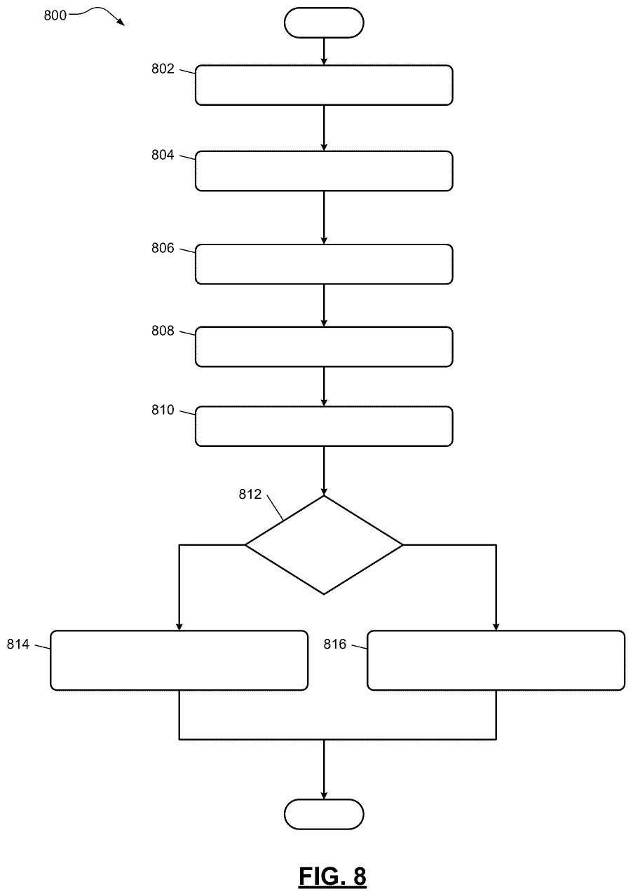

For example, FIG. 7 depicts an example system 700 for continual learning of the machine learning network 110 of FIG. 1. In this example, the machine learning network 110 is formed of multiple CNN classifiers. As shown, once the classifiers undergo training based on initial annotated training data 706, a trained ensemble defect classifier 702 is created, ready to predict for patches derived from unannotated training data 704 directly from a factory floor. This is shown by predictions on the unannotated training data 708 in FIG. 7. The predictions on the unannotated training data 708 are then evaluated and annotated if needed and leveraged as pseudo annotated training data, as shown by new annotated training data 710. Then, once the classifiers undergo continual or incremental training based on new annotated training data 710, a re-trained ensemble defect classifier 712 is created, ready to predict for patches derived from the next batch of unannotated training data 714 directly from a factory floor. This is shown by predictions on the unannotated training data 716 in FIG. 7.

In such examples, subsequent evaluation of the predictions on the unannotated training data 708 proves significantly quicker compared to assessing the journal entirely from scratch. This expedited evaluation not only saves time but also allows the human expert(s) to validate predictions, creating new annotations as needed. These annotations become valuable additions to the training set for subsequent rounds of training.

When these annotations specifically target the initially made predictions (e.g., the predictions on the unannotated training data 708), the additional information strategically addresses areas of the CNN classifiers requiring the most improvement, thereby enhancing overall performance. The retrained CNN classifiers learn from its previous mistakes, avoiding replication, and gains the capability to make accurate predictions on fresh, unannotated journals, initiating a continuous learning cycle. This iterative process can be repeated until the desired level of competency is achieved, ensuring the ongoing refinement and optimization of the inspection system 100.

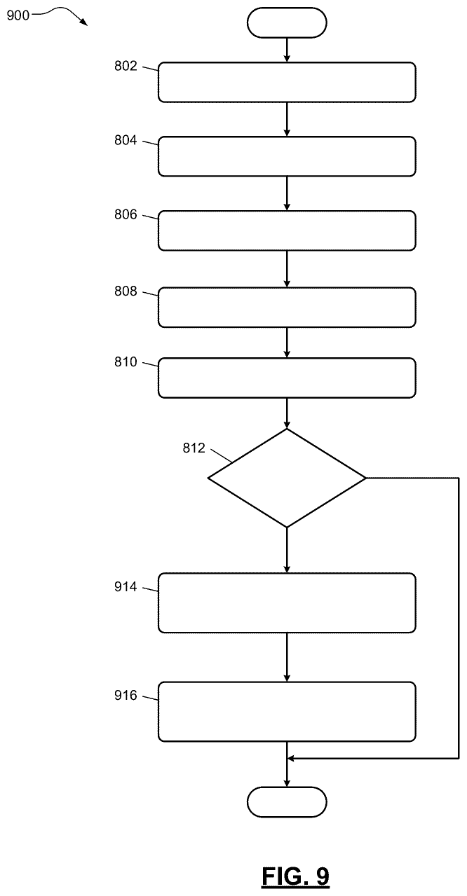

FIGS. 8-9 illustrate example inspection methods 800, 900 employable by the inspection system of FIG. 1 for automatically detecting defects of an object, such as vehicle crankshafts. Although the example inspection methods 800, 900 are described in relation to the inspection system 100 of FIG. 1 including the control module 108 and the machine learning network 110, any one of the inspection methods 800, 900 may be employable by another suitable system and/or module.

As shown in FIG. 8, the inspection method 800 begins at 802 by the control module 108 receiving annotated multi-channel image sets. In various embodiments, multi-channel image sets (e.g., the multi-channel image set 200 in FIG. 2) may be created based on captured images from the camera 106 and then analyzed and annotated by a human operator to create the annotated image sets. The inspection method 800 then proceeds to 804, where the control module 108 receives multi-channel image sets having artificially created defects. In such examples, the multi-channel image sets having artificially created defects may include multi-channel image sets of deliberately defected vehicle crankshafts and multi-channel image sets created based on transformations of existing multi-channel image sets of defected vehicle crankshafts, as explained above. In various embodiments, the annotated multi-channel image sets of 802 and the multi-channel image sets having artificially created defects of 804 may be used to train the machine learning network 110. The inspection method 800 then proceeds to 806.

At 806, a new multi-channel image set is created from a captured image of a vehicle crankshaft. For example, and as explained above, the camera 106 may capture the image of the vehicle crankshaft as it rotates, and then create the multi-channel image set based on the capture image. In other examples, the control module 108 may create the multi-channel image set based on the capture image from the camera 106. The inspection method 800 then proceeds to 808, where the control module 108 detects a boundary associated with the vehicle crankshaft based on the multi-channel image set. For example, and as explained above, the control module 108 may detect the boundary using a diffuse channel of the multi-channel image set. In such examples, the control module 108 may detect the boundary based on a change in an image brightness in the diffuse channel. The inspection method 800 then proceeds to 810.

At 810, the control module 108 detects, with the trained machine learning network 110, whether a defect exists on the boundary of the vehicle crankshaft based on the multi-channel image sets of 806, and the annotated image sets of 802 and the image sets with artificially created defects of 804. Then, if a defect is detected (yes at 812), the inspection method 800 proceeds to 814 where the control module 108 generates a control signal to control the actuator 126 to move the defected vehicle crankshaft to a defined location, such as the defect bin 128. If a defect is not detected (no at 812), the inspection method 800 proceeds to 816 where the control module 108 generates a control signal to control the actuator 126 to move the vehicle crankshaft to another defined location, such as the defect bin 130. The inspection method 800 may then end as shown in FIG. 8 or return to another suitable step if desired.

The inspection method 900 of FIG. 9 is similar to the inspection method 800 of FIG. 8 but includes alternative steps. For example, as shown in FIG. 9, the inspection method 900 beings at 802 of FIG. 8 and proceeds to 804, 806, 808, 810, 812 explained above relative to FIG. 8.

If a defect is not detected (no at 812), the inspection method 900 may end as shown in FIG. 9 or return to another suitable step if desired. If, however, a defect is detected (yes at 812), the inspection method 900 proceeds to 914 where the control module 108 generates a frequency map (e.g., a heat map) for a set of analyzed crankshafts indicating a repeating or reoccurring defect at the same spot among the set of crankshafts. This set of analyzed crankshafts may include the newly analyzed crankshaft with a detected defect of 810. The inspection method 800 then proceeds to 916, where the control module 108 generates, based on the multiple repeating defects, a notification signal to inspect a region of the machining line 102 in an attempt to resolve a potentially defect creating issue along the machining line 102. The inspection method 900 may then end as shown in FIG. 9 or return to another suitable step if desired.

By leveraging artificial intelligence to enable end-to-end visual inspection, the inspection systems and methods herein minimizes and potentially eliminates the need for human inspection, leading to cost reductions and improvements in quality, consistency, and defect detection rates. Additionally, the inspection systems and methods improve accuracy in distinguishing between acceptable (OK) and unacceptable (NOK) parts (e.g., vehicle crankshafts) as compared to conventional classifier systems. For example, the inspection systems may obtain an accuracy of 94.3% for unacceptable (NOK) parts as compared to 85.1% for conventional classifier systems. Further, the inspection systems may obtain an accuracy of 98.1% for acceptable (OK) parts as compared to 97.3% for conventional classifier systems.

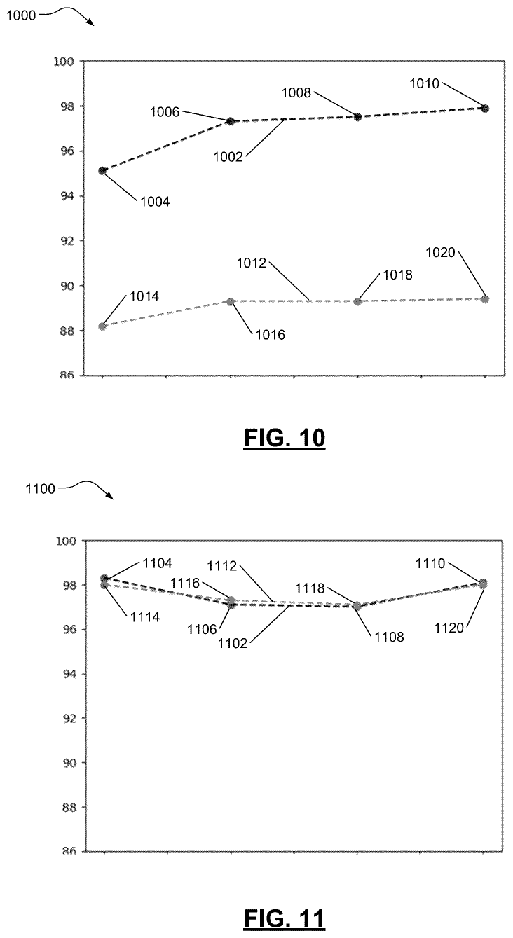

Additionally, continual learning of the machine learning network (e.g., a CNN classifier) plays a pivotal role in enhancing accuracy with respect to the inspection systems and methods herein. For example, FIGS. 10-11 depict graphs 1000, 1100 plotting performance accuracy (y-axis) over multiple rounds of continual learning (x-axis) as explained above relative to FIG. 7. Specifically, the graph 1000 of FIG. 10 shows the performance accuracy for unacceptable (NOK) parts and the graph 1100 of FIG. 11 shows the performance accuracy for acceptable (OK) parts.

In FIG. 10, the graph 1000 (unacceptable (NOK) parts) includes a line 1002 representing a CNN classifier used with one of the inspection systems herein and a line 1012 representing a conventional classifier system. In this example, points 1004, 1006, 1008, 1010 of the line 1002 represent the CNN classifier as originally trained, a first round of continual learning, a second round of continual learning, and a third round of continual learning, respectively. Additionally, points 1014, 1016, 1018, 1020 of the line 1012 represent the conventional classifier system as originally trained, a first round of continual learning, a second round of continual learning, and a third round of continual learning, respectively. As shown, the performance accuracy improves at each round of continual learning for the CNN classifier as compared to the conventional classifier system, which remains substantially steady and well below performance accuracy of the CNN classifier.

In FIG. 11, the graph 1100 (acceptable (OK) parts) includes a line 1102 representing a CNN classifier used with one of the inspection systems herein and a line 1112 representing a conventional classifier system. In this example, points 1104, 1106, 1108, 1110 of the line 1102 represent the CNN classifier as originally trained, a first round of continual learning, a second round of continual learning, and a third round of continual learning, respectively. Additionally, points 1114, 1116, 1118, 1120 of the line 1112 represent the conventional classifier system as originally trained, a first round of continual learning, a second round of continual learning, and a third round of continual learning, respectively. As shown, the performance accuracy of the CNN classifier and the conventional classifier system decrease during the first few rounds of continual learning but increased back to initial levels at the third round of continual learning (at points 1110, 1120). This is likely due to over-representation of unacceptable (NOK) patches used in the initial rounds of continual learning as compared to acceptable (OK) patches. For the third round of continual learning (at points 1110, 1120), the acceptable (OK) patches and the unacceptable (NOK) patches were more balanced, such as in the original data breakdown for the initial training (at points 1104, 1114).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. An inspection system for automatically detecting defects of an object, the inspection system comprising:
a machining line configured to support the object;
at least one camera adjacent to the machining line, the at least one camera configured to capture at least one image of the object and create a multi-channel image set of the image, each channel of the multi-channel image set providing a distinct view of the object; and
a control module in communication with the at least one camera, the control module configured to:
receive the multi-channel image set of the image;
detect a boundary associated with the object in the multi-channel image set; and
detect, with a machine learning network, a defect on the boundary based on the multi-channel image set, a first training data set including annotated multi-channel image sets, and a second training data set including multi-channel image sets having artificially created defects.

2. The inspection system of claim 1, wherein the control module is configured to:
generate a control signal in response to detecting the defect on the object; and
control, based on the control signal, an actuator to move the defected object to a defined location.

3. The inspection system of claim 1, wherein:
the detected defect on the object is one of a plurality of repeating defects associated with a plurality of objects; and
the control module is configured to generate, based on the plurality of repeating defects, a notification signal to inspect a region of the machining line for creating the plurality of objects.

4. The inspection system of claim 1, wherein the camera is configured to capture the at least one image of the object as the object rotates.

5. The inspection system of claim 4, wherein the object is a vehicle crankshaft or a camshaft.

6. The inspection system of claim 5, wherein:
the multi-channel image set includes at least a normal channel, a specular reflection channel, a diffuse channel, a gloss ratio channel, and a shape channel; and
the control module is configured to detect the boundary associated with the vehicle crankshaft or the camshaft in the diffuse channel based on a change in an image brightness in the diffuse channel.

7. The inspection system of claim 6, wherein:
the vehicle crankshaft or the camshaft includes at least one oil hole; and
the control module is configured to detect at least one edge of the oil hole based on a combination of the diffuse channel and the gloss ratio channel, and detect a defect associated with the edge of the oil hole.

8. The inspection system of claim 4, wherein:
the machine learning network is a convolutional neural network; and
the control module is configured to create a stack of overlapping patches from the multi-channel image set and detect, with the convolutional neural network, the defect on the boundary based on the stack of overlapping patches.

9. The inspection system of claim 4, wherein the second training data set includes at least one multi-channel image set of a deliberately defected object.

10. The inspection system of claim 4, wherein the second training data set includes at least one multi-channel image set created based on a transformation of a previous multi-channel image set of a defected object.

11. The inspection system of claim 1, wherein the machine learning network is continually trained based on annotated training data and unannotated training data.

12. An inspection method for automatically detecting defects of an object, the method comprising:
creating a multi-channel image set from an image of the object captured by a camera, each channel of the multi-channel image set providing a distinct view of the object;
detecting a boundary associated with the object in the multi-channel image set; and
detecting, with a machine learning network, a defect on the boundary based on the multi-channel image set, a first training data set including annotated multi-channel image sets, and a second training data set including multi-channel image sets having artificially created defects.

13. The inspection method of claim 12, further comprising:
generating a control signal in response to detecting the defect on the object; and
controlling, based on the control signal, an actuator to move the defected object to a defined location.

14. The inspection method of claim 12, wherein:
the detected defect on the object is one of a plurality of repeating defects associated with a plurality of objects; and
the inspection method further includes generating, based on the plurality of repeating defects, a notification signal to inspect a region of a machining line for creating the plurality of objects.

15. The inspection method of claim 12, wherein:
the object is a vehicle crankshaft or the camshaft; and
creating the multi-channel image set from the image of the object captured by camera includes creating the multi-channel image set from the image of the vehicle crankshaft or the camshaft captured by camera as the vehicle crankshaft or the camshaft rotates.

16. The inspection method of claim 15, wherein:
the multi-channel image set includes at least a normal channel, a specular reflection channel, a diffuse channel, a gloss ratio channel, and a shape channel; and
detecting the boundary associated with the object includes detecting the boundary associated with the vehicle crankshaft or the camshaft in the diffuse channel based on a change in an image brightness in the diffuse channel.

17. The inspection method of claim 12, wherein:
the machine learning network is a convolutional neural network; and
the inspection method further includes creating a stack of overlapping patches from the multi-channel image set; and
detecting the defect on the boundary includes detecting, with the convolutional neural network, the defect on the boundary based on the stack of overlapping patches.

18. The inspection method of claim 12, wherein the machine learning network is continually trained based on annotated training data and unannotated training data.

19. The inspection method of claim 12, wherein the second training data set includes at least one multi-channel image set of a deliberately defected object and at least one multi-channel image set created based on a transformation of an existing multi-channel image set of a defected object.

20. An inspection system for automatically detecting defects of a vehicle crankshaft, the inspection system comprising:
a machining line configured to support the vehicle crankshaft;
at least one camera adjacent to the machining line, the at least one camera configured to capture at least one image of the vehicle crankshaft as the vehicle crankshaft rotates and create a multi-channel image set of the image, each channel of the multi-channel image set providing a distinct view of the vehicle crankshaft; and
a control module in communication with the at least one camera, the control module configured to:
receive the multi-channel image set of the image;
detect a boundary associated with the vehicle crankshaft in the multi-channel image set; and
detect, with a machine learning network, a defect on the boundary based on the multi-channel image set, a first training data set including annotated multi-channel image sets, and a second training data set including at least one multi-channel image set of a deliberately defected vehicle crankshaft and at least one multi-channel image set created based on a transformation of a previous multi-channel image set of a defected vehicle crankshaft.
